(19) United States
(12) Patent Application Publication
(10) Pub. No.: US 2009/0299661 A1
(43) Pub. Date: Dec. 3, 2009

(54) METHOD AND SYSTEM FOR MINIMISING NOISE IN ARRAYS COMPRISING PRESSURE AND PRESSURE GRADIENT SENSORS

(75) Inventors: Martin Green, Stockport Cheshire (GB); Christopher Paul Walker, Glossop Derbyshire (GB); Philip Andrew Cotterill, Wilmslow Cheshire (GB)

Correspondence Address: DARBY & DARBY P.C., P.O. BOX 770, Church Street Station, New York, NY, 10008-0770, US

(73) Assignee: Thales Holdings UK PLC, Surrey (GB)

(21) Appl. No.: 12/434,314

(22) Filed: May 1, 2009

(30) Foreign Application Priority Data
May 1, 2008 (GB) 08 07992.3

(51) Int. Cl. G06F 15/00; G01H 17/00

(52) U.S. Cl. 702/54; 702/189

(57) ABSTRACT

The invention relates to a method of analyzing signals from an array of sensors, the array including one or more pressure sensor and one or more pressure-gradient sensor. The method includes combining data received from one or more pressure sensors and data from one or more of the pressure-gradient sensors, in such a way as substantially to eliminate noise components from the product. The invention also relates to a sonar system and an array configuration for implementing the method, as well as a computer readable product, storage device storing the computer readable product and computer receivable signal for implementing the method.

The present application claims the benefit of British Patent Application Serial No. 0807992.3, filed May 1, 2008, which is hereby incorporated by reference in its entirety.

The present invention relates to a method and system for analyzing signals generated from acoustic sensors in a sonar array and to a sonar array configuration.

Sonar arrays are often deployed on surface or sub-surface vessels to detect objects both on and below the surface. Typically the array comprises a group of pressure sensors, such as hydrophones, which may, for example, be towed behind the vessel, the signals from the hydrophones being fed along communication channels to be analyzed by a sonar-processing system on the vessel. The hydrophones may also be deployed on the flank and/or bow of the vessel. The signals from the hydrophones are processed by a beamformer which generates a set of directional outputs which are sensitive to the acoustic pressure coming from a particular direction.

One of the disadvantages with passive sonars, both on ships and airdropped sonobouys, is they do not generally provide range localisation associated with active sonar, however passive sonar is highly advantageous as, by not transmitting a ping, it does not reveal the presence of the sonar vessel.

Another type of array comprises acoustic vector sensors, also referred to as velocity sensors, which unlike hydrophones measure the pressure gradient.

Other sensors such as accelerometers and displacement sensors are also adapted to measure pressure gradient, but as with the vector sensor they have the disadvantage of generally being more expensive than hydrophones.

For the purpose of this specification the term pressure-gradient sensor will be used to describe a sensor such as a vector sensor, velocity sensor, accelerometer or displacement sensor.

All sensors are affected by the presence of noise. This invention is intended to provide a means of reducing noise interference from a variety of sources whilst not relying on accurate relative calibration of the pressure and pressure gradient sensors.

In particular, the effects of flow noise is a major problem when the platform is travelling at higher speeds, the higher flow noise picked up by the sensors, for example in hull mounted and towed sonar arrays, inhibits the accurate detection and/or identification of a target.

To dampen the effects of unwanted noise sources arising from vibrations transmitted through the hull of a vessel to which the array is attached baffles and decoupling mechanisms are employed to isolate as far as is possible the sensors from the hull vibrations. The baffles and ever increasingly sophisticated decoupling mechanisms become more expensive as the array size increases and also adds considerable weight to the vessel which can effect the vessel's performance. For example, the added weight to a submarine can dramatically inhibit its buoyancy and manoeuvrability.

In addition to the above extraneous noise sources there is also undesirable electrical noise generated in the system which contributes to degradation of the signal to noise ratio of signals being processed.

There is a need therefore to prevent noise components in sensed signals dominating which give rise to the many disadvantages described above with known arrays and systems.

One of the objectives of the present invention is to provide a method and system for analyzing signals from a sonar array which strives to minimise or eliminate, during the processing of the data, one or more of the unwanted noise contributions in the received signals identified above in the known systems.

According to one aspect of the present invention there is provided a method of analyzing signals from an array of sensors, the array comprising at least one pressure sensor and at least one pressure-gradient sensor, the method comprising deriving a complex number representation of data received from one or more pressure sensors and a further complex number representation of data from one or more of the pressure-gradient sensors, and multiplying one of the complex numbers with the conjugate of the other complex number.

According to one embodiment of the present invention the method comprises beamforming the signals from the pressure and pressure gradient sensors to generate complex number output signals for further signal and data processing.

In an embodiment of the invention the data derived from the pressure sensor or group of pressure sensors for a given beam can be represented by the complex number P=Pᵣ+iPᵢ, (where coefficient i is the square root of −1) and the processed data derived from the pressure-gradient sensor or group of sensors for the same beam direction can be represented by the complex number A=Aᵣ+iAᵢ, the product being derived from either P A* or P*A.

The real part of the product, Real (P*A) or the equivalent Real (A*P) may also be calculated

The method may further comprise utilizing the average values of products, derived from either PA* (or P*A) or Real (PA*) or the equivalent Real (P*A), to plot a cross spectrum of time against frequency. For the remainder of this document when referring to PA* it shall be understood that the equivalent P*A can be used instead without stating so explicitly.

The data may be processed in either the time domain or the frequency domain.

In an embodiment the above complex number representation can be from one or more pressure-gradient sensors acoustically co-located within the array and one or more pressure sensors, the acoustically co-located sensors defining a group or sub-group of the array prior to beamforming.

In a sonobuoy application, for example, it may be sufficient to acoustically co-locate one pressure sensor with one pressure-gradient sensor, although other configurations can be adopted.

In towed arrays or hull mounted arrays, a cost effective configuration is to form sub-groups of sensors. For example, one pressure gradient sensor may be associated with one, two, three, four or more pressure sensors defining each subgroup dependent on the specific operational and cost constraint requirements for the array.

Another aspect of the invention comprises a computer program product operable, when executed on a computer, to cause said computer to perform the methods as defined above. The product may itself be implemented as a storage medium, such as a magnetic or optical disk, or a memory device, or a hardware implementation such as an ASIC or the like.

Also the invention provides a computer receivable signal carrying a computer program product operable when executed on a computer, to cause said computer to perform the methods defined above.

According to another aspect of the invention there is provided a sonar system comprising an array of acoustic sensors and a data processor, characterised in that the array comprises at least one pressure sensor and at least one pressure-gradient sensor, the data processor being adapted to receive the complex number representation from one or more of the pressure and pressure gradient sensors and to derive a product by multiplying one of the complex numbers with the conjugate of the other complex number.

According to an embodiment of the invention the sonar system also comprises a beamformer, the output signals from the sensors being electronically connected directly or indirectly to the beamformer, the output signals from which are electronically connected directly or indirectly to the data processor, the data processor being adapted to derive from the signals received from the beamformer both the complex number representative of data received from one or more of the pressure sensors and the further complex number representative of data received from one or more of the pressure-gradient sensors.

In a further embodiment of the invention there is provided a sonar system comprising a sonar array, the array comprising a plurality of acoustic sensors for measuring pressure and a plurality of pressure-gradient sensors, the acoustic sensors for measuring pressure and the pressure-gradient sensors defining respective sub-arrays within said array, a beamformer for beamforming each of the sub-arrays independently, a signal processor for normalising in the steer direction of each beam to a predefined acoustic sensitivity and for forming from said normalised data cross-spectra between corresponding pressure and pressure-gradient beams.

According to another aspect of the invention there is provided a sonar array comprising at least one pressure sensor and at least one pressure-gradient sensor.

In one embodiment of the array, at least one pressure sensor and at least one pressure-gradient sensor are acoustically co-located within the array. In a sonobuoy application, for example, it may be sufficient to acoustically co-locate one pressure sensor with one pressure-gradient sensor, although other configurations can be used as previously described.

In another embodiment of the array a pressure-gradient sensor is acoustically co-located with a plurality of pressure sensors which together form a group or a sub-group of sensors within the array. The sub-group of sensors may also define sub-arrays within the array.

The sensors employed for use in an array may act as receivers for passive or active sonar dependent on the operational requirements of the system.

Embodiments of the invention will be described further by way of specific examples with reference to the accompanying drawings, in which:

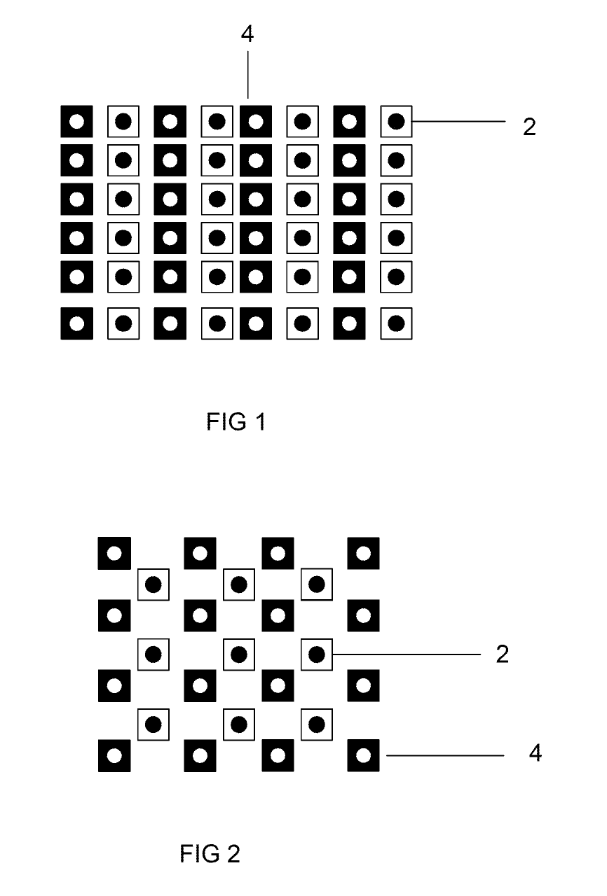

FIG. 1 is a schematic diagram of a sonar array according to a first embodiment of the invention;

FIG. 2 is a schematic diagram of a sonar array according to a second embodiment of the invention;

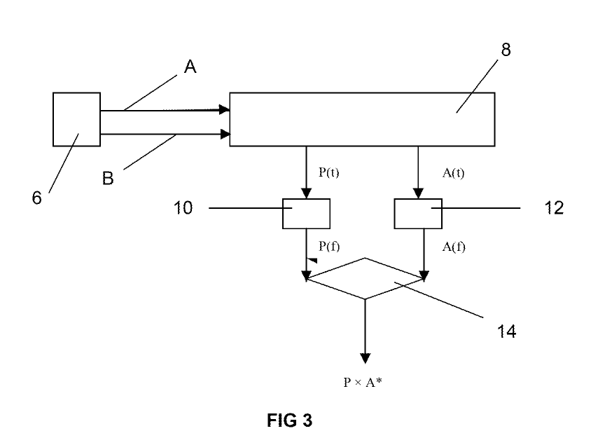

FIG. 3 is a block diagram of a system in accordance with an embodiment of the present invention and

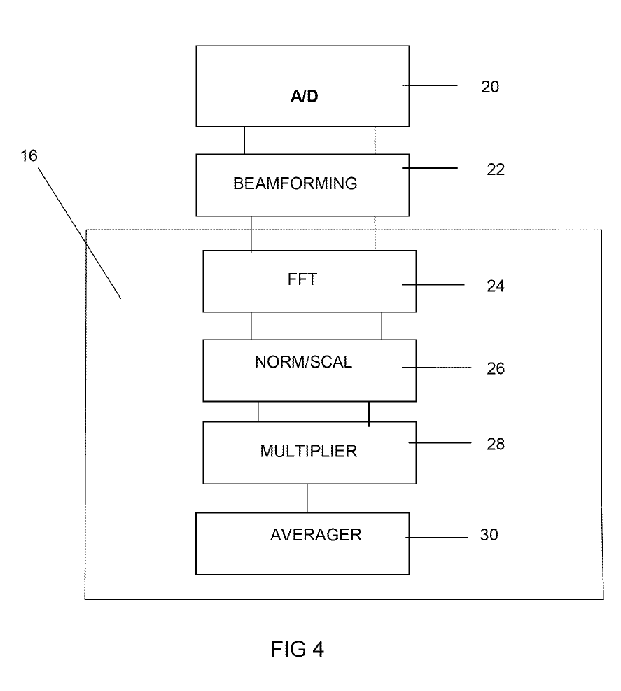

FIG. 4 illustrates a flow diagram of the implementation of the specific embodiment of the invention.

In the following description, specific implementations of the invention are described. It will be appreciated by the reader that these are provided by way of example only, and are not intended to provide restriction or limitation on the scope of the invention, which is defined in the appended claims.

Referring to FIG. 1, a sensor array 6 according to a first embodiment of the invention comprises a plurality of acoustic sensors 2, 4 configured as alternate columns of pressure sensors 4 and pressure-gradient sensors 2, as shown in FIGS. 1 and 2 although many other configurations can be adopted dependent on cost and operational requirement.

With reference to FIG. 2, a sensor array according to a second embodiment of the invention comprises a plurality of acoustic sensors similar to those shown in FIG. 1 but with a different configuration. As in the embodiment of FIG. 1 the different types of sensors 2, 4 are arranged in alternate columns however the number of pressure-gradient sensors 2 are reduced in number. It will be appreciated that the ratio, and relative configurations, of the number (Nₚ) of pressure sensors to the number of pressure-gradient sensors (Nₐ) are chosen to meet both cost and operational requirements. Accordingly, for a sonobuoy it may be sufficient to employ just one pressure sensor and one pressure-gradient sensor together, giving a ratio:

N_{P}:Nₐ=1:1=1

However as stated above provided there is at least one pressure sensor and one pressure-gradient sensor this ratio can vary widely such that the ratio is less than, equal to or greater than one.

The sensor array can be part of a towed array or mounted on the flank or bow of a vessel. In both of the embodiments each of the two different types of sensors 2, 4 are coupled to a beamformer, described later, where they are independently beamformed.

The configurations shown in FIGS. 1 and 2 are shown by way of example only to illustrate just two of the numerous different configurations in which the different types of sensors 2, 4 can be arranged.

A system in accordance with an embodiment of the invention is illustrated in FIG. 3 in which a sensor array 6, comprising a configuration of pressure and pressure-gradient sensors, is connected to a beamformer 8 by a series of channels, only two of which, channels A and B, are shown in FIG. 3 for the purpose of simplicity of illustration.

The beamformer 8 operates to select the output signal from one or more of the gradient sensors 2 and one or more of the pressure sensors 4 selecting them as elements from the overall array configuration for a desired sub-array configuration sensitive to an acoustic beam using the selected output signals. The different types of sensors 2, 4 are beamformed independently, each of channels A and B connecting the beamformer 8 to output signals from a respective group of selected pressure-gradient sensors 2 and pressure sensors 4. Channel A connects the beamformer 8 to one or more of the pressure-gradient sensors 2 within the array 6 whilst channel B connects the beamformer 8 to one or more of the pressure sensors 4 within the array 6. The pressure-gradient sensors 2 and pressure sensors 4 selected will be associated with the selected acoustic beam direction to be monitored.

The beamformer 8 provides outputs each representative in the time domain P(t) and A(t) associated with the respective pressure and pressure-gradient sensors. This data is fed to a data processor, shown generally by boxes 10, 12 and 14 in FIG. 3 the operation of which will now be described.

The time domain data P(t) of each beam is Fourier transformed to provide signals P(f) shown as an output signal from box 10. Likewise the time domain data A(t) is of each beam is Fourier transformed to provide a signals A(f) shown as an output signal from box 12. The output from the Fourier Transform provides the respective numbers P(f) and A(f). The complex numbers P(f) and A(f) derived are processed by multiplying one of the complex numbers with the conjugate of the other and then averaging as shown in box 14 of FIG. 3. The mathematical theory will be described in more detail below with an explanation for selecting the product PA*.

The amplitude of the processed data derived from the pressure sensor or group of pressure sensors for a selected beam direction can be represented by the complex number:

P=Pᵣ+iPᵢ

The amplitude of the processed data derived from the pressure-gradient sensor or group of pressure-gradient sensors for the same beam direction can be represented by the complex number:

A=Aᵣ+iAᵢ

The combination of pressure and pressure gradient sensors forms a directional pattern referred to herewith as cardioids.

The combined cardioids power of the two signals is proportional to |P±A|²=|P|²+|A|²±2 real (PA*)).

For many noise sources there is little or no correlation of noise between the two types of sensor or the noise product goes into the imaginary part of PA* thus the cardioid powers are dominated by the noise in the |P|² and |A|² terms.

To substantially eliminate noise a process of cross-sensor processing employed in the system of FIG. 3 uses the cross term PA*, taking the real part of that term which contains significantly reduced noise but the bulk of the acoustic signal.

Taking the complex numbers above the product of P and A* can be expressed as

P A *=(Pᵣ+iPᵢ)(Aᵣ−iAᵢ)=PᵣAᵣ+P_{iA}ᵢ+i(PᵢAᵣ−PᵣAᵢ)

Real(PA*)=PᵣAᵣ+PᵢAᵢ=Real (P*A)

Plotting the cross spectrum of the average values of Real(PA*) it has been found the noise levels are much reduced and it is possible to discern more clearly target information.

FIG. 4 illustrates a flow diagram of the implementation of an embodiment of the invention. As described earlier the pressure gradient sensors (hydrophones) and pressure-gradient sensors can be thought of as sub-arrays that are independently beamformed. In FIG. 4 this is shown by the beamforming step 22, which is fed from an analogue to digital converter step 20. The outputs of the beamformer (step 22) are fed to the processor 16 which has a plurality of sub-functions only some of which are shown in FIG. 4. The separate outputs from the beamformer are Fourier transformed at step 24. The frequency domain outputs may normalised and scaled at step 26 as appropriate for each beam to provide two complex numbers P and A as previously described.

Cross-spectra data is created between corresponding pressure and pressure gradient beams by means of the multiplier 28, which is adapted to multiply one of the complex numbers with the conjugate of the other. The real part of the output of the multiplier is averaged (step 30). The real part of the product gives a term which is proportional to the acoustic intensity in a given beam direction which is substantially free of extraneous noise.

In towed arrays Cross Spectral Processing eliminates flow noise, which is uncorrelated between pressure sensors and pressure gradient sensors. The desired acoustic signal is found in the real part of the cross-spectrum with a sign that depends upon the direction (left or right) of the incoming sound wave thus the left-right ambiguity is resolved. In hull mounted arrays, flow noise and sub-sonic components of hull-born noise are found in the imaginary part of the cross spectrum whereas the desired acoustic signal is found in the real part thus the processing separates out the signal power from the non-acoustic noise power. If the pressure gradient sensor is an accelerometer or a displacement sensor, common mode electrical interference is found in the imaginary part of the cross-spectrum in both towed and hull mounted arrays and hence is separated from the desired acoustic signal.

The above describes an array comprising both sets of sensors that can be processed using a Cross Sensor processing technique of combining the sensors so as to reduce self-noise and flow-noise. Whereas specific reference has been made above to applications such as towed arrays and hull mounted sonar arrays (such as flank arrays), one or more embodiments of the invention can be used for other applications such as in a sonobuoy and sensing in other domains such as in-air acoustics.

One or more embodiments of the invention also provide an alternative means of resolving the left-right ambiguity, inherent in conventional towed arrays of on-axis hydrophones, to triplet arrays of off-axis sensors (which are more sensitive to flow noise).

Existing hull mounted and towed sonar arrays are sensitive to flow noise at higher platform speeds, particularly if pressure gradient sensors are used in flank arrays, or if off-axis or pressure gradient sensors are used in towed arrays to resolve the left-right ambiguity. The one or more embodiments of the present invention provide a way of using such arrays in a manner that is comparatively insensitive to flow noise.

It will be appreciated that in hull arrays, whereas pressure gradient sensors provide a means of rejecting hull-born vibration when combined with hydrophones, without the method used in one or more embodiments of the present invention such configurations are very sensitive to flow noise. Similarly in towed arrays, pressure gradient sensors can be combined with hydrophones to resolve the left-right ambiguity but without the methods of this invention they are very sensitive to flow noise.

In addition to one or more embodiments of the present invention providing a means of reducing both hull vibration and flow noise as well as resolving the ambiguity on towed arrays, it has also been found that common mode electrical interference between the signals is also reduced when an accelerometer or displacement sensor is used to sense the pressure gradient; similar rejection would not be achieved with a velocity sensor.

One or more embodiments of the invention therefore provides a solution that minimises both flow and hull vibration noise sources and also reduces common mode electrical interference. It also provides a means of resolving the left-right ambiguity in towed arrays without using off-axis sensors, which are more prone to flow noise. It also provides the potential to produce thinner (and hence cheaper and lighter) hull mounted arrays as the requirement for mechanical decoupling from hull and flow based vibration is reduced.

1 A method of analyzing signals from an array of sensors, the array comprising one or more pressure sensors and one or more pressure-gradient sensors, the method comprising the steps of:
deriving a first complex number representation of data received from one or more pressure sensors;
deriving a second complex number representation of data received from one or more pressure-gradient sensors; and
multiplying one of the complex number representations with a conjugate of the other complex number representation, to form a complex product.

2 A method as claimed in claim 1, further comprising the steps of:
beamforming the signals from at least a portion of the one or more pressure sensors and the one or more pressure-gradient sensors to generate output signals for a beam direction;
wherein the deriving steps further comprise the step of processing said output signals to derive the first complex number representation of data received from said one or more pressure sensors and to derive the second complex number representation of data from said one or more pressure-gradient sensors.

3 The method as claimed in claim 2 wherein the one or more pressure sensors are beamformed independently from the one or more pressure-gradient sensors.

4 The method as claimed in claim 1, further comprising the step of deriving the complex product from one of P A* and P*A,
wherein:
the data derived from the one or more pressure sensors for a beam direction can be represented by the complex number P=Pᵣ+iPᵢ; and
the processed data derived from the one or more pressure-gradient sensors for the same beam direction can be represented by the complex number A=Aᵣ+iAᵢ.

5 The method as claimed in claim 4 wherein a real part of said complex product is derived from one of Real (P A*) and Real (P*A).

6 The method as claimed in claim 5, further comprising the step of:
deriving the average values of products, derived from one or more of P A*, P*A, Real (P A*), and Real (P*A), in order to plot a cross spectrum of power in a cross beam direction against frequency.

7 The method as claimed in claim 1, further comprising the step of combining one or more of acoustically co-located sensors into a sub-group of the array before beamforming.

8 The method as claimed in claim 2, wherein a step of normalizing is applied to the beamformed signal.

9 The method as claimed in claim 2, wherein the signals from the sensors are passed through an analog to digital converter before beamforming in a steer direction for each beam.

10 The method as claimed in claim 2, comprising Fourier transforming the signals after beamforming in a steer direction for each beam.

11 A sonar system comprising an array of acoustic sensors and a data processor, wherein the array of acoustic sensors comprises one or more pressure sensor and one or more pressure-gradient sensor, the data processor being adapted to implement a method of analyzing signals comprising the steps of:
deriving a first complex number representation of data received from the one or more pressure sensors;
deriving a second complex number representation of data received from the one or more pressure-gradient sensors;
multiplying one of the complex number representations with a conjugate of the other complex number representation, to form a complex product;
beamforming the signals from at least a portion of the one or more pressure sensors and the one or more pressure-gradient sensors to generate output signals for a beam direction; and
wherein the deriving steps further comprise the step of processing said output signals to derive the first complex number representation of data received from said one or more pressure sensors and to derive the second complex number representation of data from said one or more pressure-gradient sensors.

12 The sonar system as claimed in claim 11, further comprising a beamformer, wherein:
the output signals from the sensors are electronically in communication with the beamformer;
the output signals from the beamformer are electronically in communication with the data processor; and
the data processor is adapted to apply the method of analyzing signals to the signals received from the beamformer.

13 The sonar system as claimed in claim 11, wherein the system is adapted to beamform independently the one or more pressure sensors and the one or more pressure-gradient sensors into a same beam direction.

14 The sonar system as claimed in claim 12, wherein the array of acoustic sensors comprises one or more acoustically co-located pressure sensors and one or more pressure-gradient sensors, that are combined into acoustically co-located sub-groups prior to beamforming.

15 The sonar system as claimed in claim 12, further comprising a normalizer to normalize the beamformed signals in a steer direction of each beam.

16 The sonar sensor as claimed in claim 12, further comprising an analog to digital converter for converting the output signals from the sensors, to provide digitized sensor data to the beamformer.

17 The sonar system as claimed in claim 12, wherein the data processor is programmed to implement a Fourier transform to Fourier transform signals from the beamformer.

18 The sonar system as claimed in claim 11, wherein the one or more pressure sensors and the one or more pressure-gradient sensors form sub-groups within the array of sensors.

19 A sonar array comprising one or more pressure sensor and one or more pressure-gradient sensor.

20 The sonar array as claimed in claim 19 wherein the one or more pressure-gradient sensor is acoustically co-located with the one or more pressure sensor to form a sub-group of sensors within the sonar array.

21 The sonar array as claimed in claim 20 wherein one or more sub-groups of sensors form a sub-array within the sonar array.
